(19) United States
(12) Patent Application Publication
(10) Pub. No.: US 2003/0182183 A1
(43) Pub. Date: Sep. 25, 2003

(54) Multi-car-pool organization method

(76) Inventor: Christopher Pribe, Cupertino, CA (US)

Correspondence Address: CROWELL & MORING LLP, INTELLECTUAL PROPERTY GROUP, P.O. BOX 14300, WASHINGTON, DC, 20044-4300, US

(21) Appl. No.: 10/101,495

(22) Filed: Mar. 20, 2002

(51) Int. Cl. G06F 17/60

(52) U.S. Cl. 705/13

(57) ABSTRACT

A method of organizing a multi-car-pool comprising a leading car and at least one follower customer car, comprising the steps of registering participants, each of them potentially being a chauffeur of the leading car and/or a following customer in the multi-car-pool in a central service organization, providing a electronic service platform to enable registered participants to submit their intended driving route and driving direction and travelling timeframe to the central service organization, assembling participants having submitted their intended driving route and driving direction and travelling timeframe, who are having the same intended driving direction and overlapping travelling timeframe and sharing at least a part of their routes to build a multi-car-pool by the central service organization, and submitting information to a chauffeur and a customer assembled to build the multi-car-pool to enable the identification of each other. The service platform is implemented as an internet application.

### FIELD OF THE INVENTION

This invention relates to a method of organizing multi-car-pools consisting of a chauffeur in a leading car and at least one customer in a following car. Such multi-car-pools are also called platoons. The method is termed “chauffeur-connect” in the following brief description of the invention.

Chauffeur-connect is a service that allows drivers to use telematics to engage another car (the chauffeur) in order to drive them using “electronic tow bar technology”. The drivers can then enjoy the resulting freedom from driving in order to use the full range of mobile e-commerce services either already available in the cars or obtainable on demand from the chauffeur.

Redefining vehicle platooning as a service exposes a number of problems to be addressed. Those who deploy the service must enable consumers to evaluate the reliability of drivers. They must assure all stakeholders that platooning is safe. They must find a means to enable secure and accurate billing and payment. Finally, they must find a means to address new liability issues introduced by platooning. Successful resolution of these issues will transform vehicle platooning into a service that has the potential to be one of the primary drivers for the adoption of telematics technology.

The issues related to platooning fall in three general categories:

Platooning Technology

Service Issues

Policy Issues

Driving in or driving a platoon poses challenging legal problems as well. Incidents caused by technical failures or human error will automatically involve all vehicles in the platoon. The liability of the vehicle manufacturer, the driver of the platoon and the platoon participants is a rather complex issue and would depend on the service agreement between the driver and the customer as well as the technical design of the system.

By redefining vehicle platooning as a service and adding the missing elements, platooning can be made viable in the real world. According to the invention, the chauffeur-connect service combines platooning technology with Internet, wireless, and video technologies to enable new business models for vehicular transportation.

### BACKGROUND OF THE INVENTION

The foundations in platooning technology have been investigated in various research projects and are ready for deployment in everyday (drive-by wire) vehicles. Vehicles are connected to each other by means of an “electronic tow-bar”. The vehicle in front takes over the controls of the remaining vehicles in the platoon and the group of vehicles behaves as if they are one, long vehicle. Issues related to joining and leaving platoons, lane changing, as well as emergency situations have also been studied. The technological foundations for platooning have been developed and the technology is available. The idea of vehicle platooning is neither a complete nor mature offering for consumers. Moreover, platooning raises several questions not solved in the prior art, such as:

Who would put his life in the hands of just any other drive?; and

Why would anyone want to act as the driver of a platoon and take on the extra responsibility?

A variety of issues, ranging from trust and liability to safety and security, must be successfully addressed in order to make vehicle platooning viable in the real world. As long as the number of vehicles capable of platooning does not reach a critical mass, the chances of finding a potential platooning partner will remain slim and the cost associated with equipping vehicles with this technology will go to waste. Platooning is only feasible if vehicle owners and manufacturers see a realistic added benefit to using this technology.

The present invention seeks to organize multi-car-pools to generally overcome the problems underlying the implementation of the commercial use of platooning, preferably using electronic tow bar technology, telematics and e-commerce services.

### SUMMARY OF THE INVENTION

In order to solve the above-mentioned problems, a method of organizing a multi-car-pool is provided, in which multi-car-pool, a leading car and at least one follower customer car are operating. The method comprises the acts of registering participants, each of them potentially being a chauffeur of the leading car and/or a following customer in the multi-car-pool in a central service organization, providing a electronic service platform to enable registered participants to submit their intended driving route, driving direction and travelling timeframe to the central service organization, assembling participants having submitted their intended driving route, driving direction and travelling timeframe, who are having the same intended driving direction and overlapping travelling timeframe and sharing at least a part of their routes to build a multi-car-pool by the central service organization, and submitting information to a chauffeur and a customer assembled to build the multi-car-pool to enable the identification of each other.

It is preferred that the multi-car-pool is an electronic tow-bar platoon. Electronic tow bar technology is known and is described here only to the extent necessary to understand the present invention. The assembling of the participants can be done by bringing together participants and enabling them to negotiate via the central service organization. The service platform may be equipped to enable the participants to submit their intent whether they are willing to be a chauffeur or a customer to the central service organization.

The method according to the invention may further comprise the steps of displaying participants, who submitted their intent to be willing to be a chauffeur, to at least one participant by the electronic service platform, and the electronic service platform enabling these participants to submit a chosen chauffeur of the displayed chauffeurs to the central service organization. There is therefore introduced a negotiating process between registered participants to assemble a platoon via the electronic service platform.

It can be expected that some of the participants have a bad feeling of participating in platoons which are extending a specific length, so the service platform further may enable the participants to submit to the central service organization a maximum number of cars building the multi-car-pool they want to join.

It is advantageous to provide the service platform as an internet application. This enables a large variety of additional benefits. One of these benefits can be achieved if the service platform offers entertainment programs and/or news services to the customers. In this case, there is the possibility to charge additional fees to the customer for downloading the programs or services.

The basic assumption of chauffeur-connect service is that people would rather pay a fee for their vehicle to be driven than to have to drive their own car on long trips or during commutes. For the services offered by the central service organization a fee can be charged, so there is an easy feasible benefit for the providers of the technology used to employ the method according to the invention described.

There is no doubt that consumers would be willing to pay to reduce the burden of driving. Vehicle platooning is one way to achieve this. However, for vehicle platooning to be successful under real market conditions, it must achieve the high standards required of any consumer product. These products and services must be something that consumers can trust and feel good about buying. Successful mass-market products and services need to offer a seamless, end-to-end experience for consumers. According to the invention it is proposed to cast vehicle platooning in a service framework and extend it by adding the missing elements. In the proposed chauffeur-connect service, customers would pay to be driven. The chauffeur connect service uses telematics to help people find a lead vehicle or ‘co-driver’, enable payment for co-driving, and to support mobile e-commerce between vehicles and others. The service business approach recognizes the asymmetry between those driving and those being driven.

Once the drivers and occupants of the trailing vehicles are relieved of the burden of driving, they will serve as a mobile e-commerce platform and potential value added services can be provided by the central service organization. This could also result in the chauffeur-connect service being free of charge for the customers.

In addition to freeing up the drivers of the trailing cars, vehicle platoons have also been shown to increase the efficiency of roadways and reduce fuel consumption. The method of the invention enables society to achieve the advantages of platooning.

The value created by this service is substantial. The service could easily save a luxury-class car owner 400 hours of driving per year. If we put each hour's worth at $150—a reasonably amount considering the range of productive e-commerce services available to his use, he reaps benefits worth $60,000 per annum. The provider of the chauffeur-connect service would, naturally, be entitled to its share of the amount for enabling it. The new revenue streams would pay for the cost of introducing sophisticated vehicle automation and telematics hardware in the cars. E-commerce through the service providers proprietary platform would generate further revenue. Automation technology can be incrementally leveraged. Customer satisfaction for car manufacturers deploying their cars with the platooning technology increases too.

Other objects, advantages and novel features of the present invention will become apparent from the following detailed description of the invention when considered in conjunction with the accompanying drawings.

### BRIEF DESCRIPTION OF THE DRAWINGS

The present invention will become more fully understood from the detailed description and the accompanying drawings, in which:

FIG. 1 is a pictorial illustration of the transaction flow in a chauffeur-connect system;

FIG. 2 is a pictorial illustration of the client-server architecture of the chauffeur-connect system;

FIG. 3 is a pictorial illustration of the front-end and back-end interaction of the chauffeur-connect client-server system; and

FIGS. 4-21 illustrate the appearance of a chauffeur-connect prototype display for its users.

### DETAILED DESCRIPTION OF THE PREFERRED EMBODIMENTS

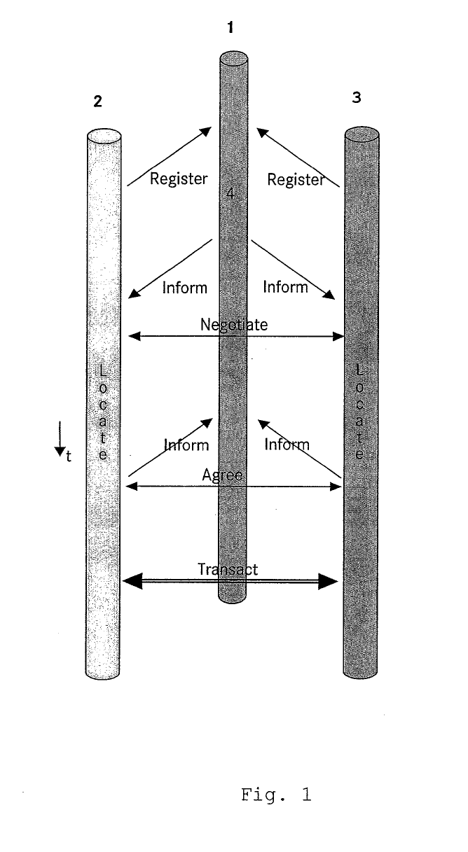

Referring to FIG. 1, the transaction flow between the central service organization 1, the customer 3 or customer and the chauffeur 2 in a chauffeur-connect system is described. In such a service, the chauffeur would offer his services as a driver and customers would attach themselves to his vehicle to form a platoon. From the view of the customer, the steps involved in this interaction are:

Identifying a suitable chauffeur (identification)

Negotiating the terms and how to connect (negotiation)

Obtaining the service (transaction)

The chauffeur-connect service can be designed as a server-client type application. First, both the potential customers and the chauffeurs have to register themselves with the server, which constantly tracks the location and availability of chauffeurs and customers. Initial selection of a suitable chauffeur is done by geographical proximity, driving direction, required travel speed and technical equipment. As a second step, additional services can be used to evaluate and rank the candidate chauffeurs and broadcast the information to the interested participants.

Both the chauffeurs and the customers have to register and update the following information with the central server at the central service organization:

Current Location

Intended driving route and Direction/Destination

Travel Speed/Timeframe

Technical Equipment

Additional Interest/Services available

The current location is used to ensure that the vehicles offering and looking for the service are in close proximity. The destination and the current driving direction are of importance. The travel speed and timeframe determine the suitability of the chauffeur for certain types of travel. If someone would like to get to a location as soon as possible, a leisure cruise type of platoon will definitely not suit his needs. So the time frames of the participants who can be assembled 4 to build a platoon have to match or at least overlap. The technical equipment will have to be verified for compatibility issues and in order to ensure that potential additional services can be used. The additional services of interest are the list of offerings (e.g. movies, high bandwidth internet access, tourist information) that the chauffeur offers and the customer has interest in.

While some of this information is dynamic and needs to be updated constantly, e.g. location, driving direction, other information is static and will be updated only when changes occur, e.g. services offered.

Technically, this system can be realized as a client-server application with a central database server and a low bandwidth wireless data exchange between the vehicles and the central server. Having all relevant information on a central server reduces the amount of communication needed between vehicles (static data does not need to be re-transmitted) and has benefits in terms of reliability and trust. When a request for a chauffeur arrives at the central server, the following steps are performed:

Find chauffeur(s) with matching destination

Filter chauffeur(s) with matching timeframe

Filter chauffeur(s) with matching technical equipment

Sort chauffeur(s) with respect to overlap in interests and offered additional services

Once a suitable chauffeur is found, the information regarding the chauffeur and the potential customer are broadcast to the interested participants. The participants are informed of at least information enabling them to identify each other.

Once the identity and relevant information of the potential chauffeur and customers are transmitted from the server to the interested parties, peer to peer negotiations start. These negotiations are introduced via the central service organization. Pricing, direction, duration, merging points and additional services offered are verified and determined. If an agreement is reached, the customer joins the platoon at a negotiated merging point.

This interaction takes place using low bandwidth wireless peer to peer communications, e.g. wireless internet access. For example, the customer can be charged a fee for getting the identification information concerning the chauffeur of the assembled platoon.

After the customer has joined the platoon, the chauffeur vehicle takes over the controls of the trailing vehicle and starts to drive. This is the basic service concept of chauffeur-connect. However, since the vehicles are at close range and the drivers of the trailing vehicles do not have to drive any longer, one can envision providing additional, premium services using high bandwidth wireless communication links between the vehicles. In FIG. 1, thin arrows depict low bandwidth communications, and the double lined arrow depicts high bandwidth communications between the vehicles of the platoon (Transact), e.g. the transmission of a cameras view of the road ahead from the chauffeur to the customers.

It should be noted that the technical equipment needed to provide a chauffeur service and the equipment needed to use this service are not identical. While the trailing vehicles need equipment to enable remote drive-by-wire access to their vehicles, the leading vehicle will need additional computational, mechanical and telecommunication capabilities to be able to control the trailing vehicles. Depending upon whether the lead vehicle wants to provide additional services other than the chauffeuring service, it will need facilities for these as well. The trailing vehicles will need a suitable receiver to be able to utilize these services.

A successful chauffeur-connect service should take into account that the vehicles within the platoon have comparable technical specifications. Mixing vehicles with a wide range of technical specifications could cause the vehicles within the platoon to behave in a non-uniform manner, which could cause dangerous situations, e.g. one vehicle will take longer to stop after the brakes are engaged than the other. While the suitable chauffeurs are matched with the potential customers, the technical specifications should be verified to ensure overall compatibility with the remaining vehicles in the platoon as well.

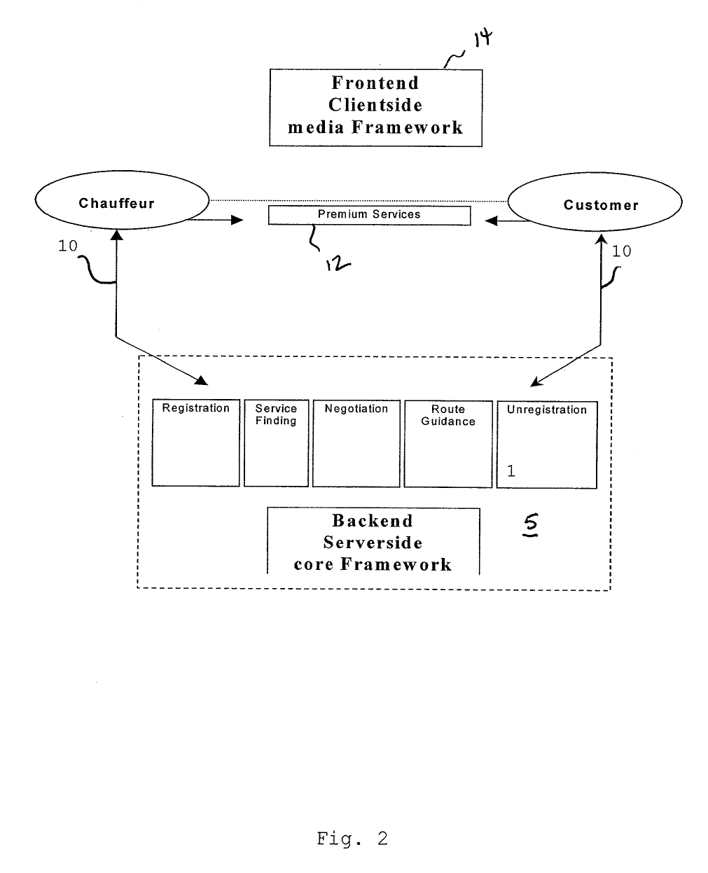

Referring to FIG. 2, the client-server architecture of the chauffeur-connect system is described. The Backend Serverside core Framework is implemented on a server located at the central service organization 5. The chauffeur and the customer are communicating 10 with the central service organization 5. The chauffeur and the customer are in contact too. In addition to the communication necessary to build the platoon, the chauffeur offers Premium Services 12 to the customer. These Premium Services may include, e.g. the transmission of entertainment programs or news stories. The contents of the Premium Services may be downloaded from the central service organization or offered by the chauffeur himself, e.g. a service transmitting a camera view of the road ahead. The technology enabling the participants to participate in the premium services is called Frontend Clientside media Framework 14 in FIG. 2. The chauffeur and the customer have different roles in the system. The chauffeur can be discerned as a service provider whereas the customer using these services acts as a service consumer. The customer requests a service and the chauffeur responds to the service request.

The architecture behind chauffeur-connect is a typical client-server based two-tier infrastructure. Clients use services provided through the server applications in the backend. In the backend, typical server side applications are the registration and unregistration of users, the negotiation between the chauffeur and their customers and route guidance. These tasks are carried out by different server instances.

The Route Guidance system is a service that allows the customer to find the best way to its chauffeur. Sophisticated routing algorithms combined with GPS-based navigation can be used to implement the Route Guidance System.

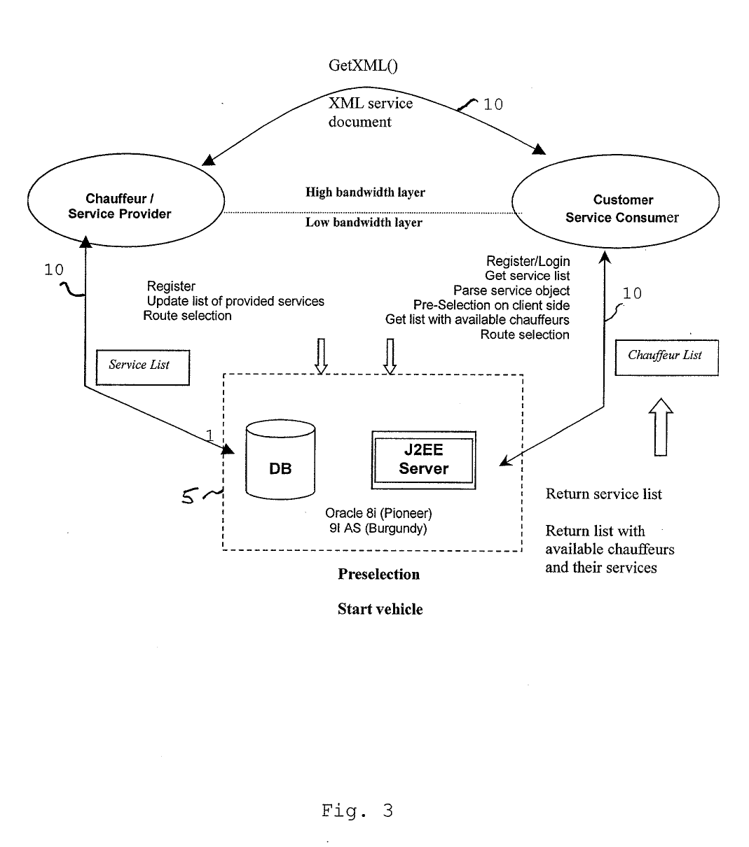

Referring to FIG. 3, in a pictorial illustration of the front-end and back-end interaction of the chauffeur-connect client-server system, the basic components of the system are described in the following. The communication 10 directly between chauffeur and customer is based on a high bandwith layer, e.g. implemented in Extensible Markup Language (XML). Communications 10 the central service organization 5 is involved in is based on a low bandwith layer.

A database server is responsible for the storage of data. A Java Enterprise Edition Server (e.g., a J2EE™) provides a centralized message service (JMS) between the different instances participating in chauffeur-connect. Chauffeur-connect uses a relational database to store and retrieve data (e.g., an Oracle™ database Oracle™ 8i.17). The database consists of several tables with dependencies. The tables store information about the users of chauffeur-connect, the available services, and the locations and positions of the user. This mapping of the information into relational data objects is described below. In the chauffeur-connect service implementation, entities are the users of the application. Users are divided into chauffeurs providing services or customers using them. The users are driving in their vehicles from one point to another. Both chauffeurs and customers use their accounts to login to the chauffeur-connect-service. Each user has a login account to register himself and the vehicle he is using to chauffeur-connect. Each chauffeur provides one or more services. The customer can choose the services he is looking for from a list of services. After a service requester has found a chauffeur who provides the service, they have to negotiate. Every time a service requester looks for available chauffeurs the system needs information about the current position and the remaining route of both parties. To allow the route guidance system to find suitable chauffeurs and to find a merging point of a chauffeur and its customers, it must be aware of the existing junctions and the paths from one junction to every other junction. Junctions and a path matrix with routing information are necessary in the core framework of chauffeur-connect. The merging point is the nearest junction where the customer can hook up to a chauffeur. The information about the current position and the remaining path is stored in a database table. If a customer wants to hook up, the Route Guidance system looks into this table, queries the first matching junction of both remaining paths and calculates the distance to this point. The Route Guidance system uses this information to speed up the customer so that both customer and chauffeur merge at the same time at the predicted junction (its assumed that chauffeurs don't change their speed). Once they merged and are in a sufficiently near proximity to one another, the electronic tow bar is able to engage and the customer can use the services provided by the chauffeur. For registration, the chauffeur sends a list with services he or she provides. The registration service updates a database with the items in the list.

The registration process for customer applications varies from the process of the chauffeur registration. The customer requests one or more services to choose from a list of available services that he or she selected during the registration process. This selection adds different weights to services the customer is keen on or doesn't care about. For the sake of privacy this selection is stored on the customer side and the registration service transmits a list with chauffeurs and the services they provide. After these steps, both the chauffeur and the customer select their route to drive. This route path will be stored in a database and the database login table will be updated. The registration service now informs the Route Guidance system to start a vehicle and the customers open a connection to a queue in order to send service requests. The registration process is now completed.

If a customer is willing to disconnect from the service an unregistration process has to be introduced. The unregistration process stops everything the client is involved in and brings the database up-to-date. Service consumer terminates, if necessary, their connections to the high bandwidth services and disconnects from the electronic tow bar. The chauffeurs can't unregister from chauffeur-connect services as long as clients are using one of the services they provide. The Route Guidance system will stop to calculate the position and terminate the vehicle thread.

This chauffeur list has been pre-selected on the server side. The list contains only chauffeurs with the same route elements as the customer and the destination junction is in the path of the chauffeur. The list of chauffeurs contains:

the name of the chauffeur

the provided services

the distance to the nearest merging point

The customer application uses this list and combines each entry with the service settings and tries to find the best fitting chauffeur.

Whenever a customer requests the usage of a service, the chauffeur gets a notification. The chauffeur can agree or disagree to this service request. Once the chauffeur agrees to the request, then the Route Guidance system will guide the customer to hook up at a predicted merging point. Otherwise, the customer has to request another chauffeur which is driving in the same direction.

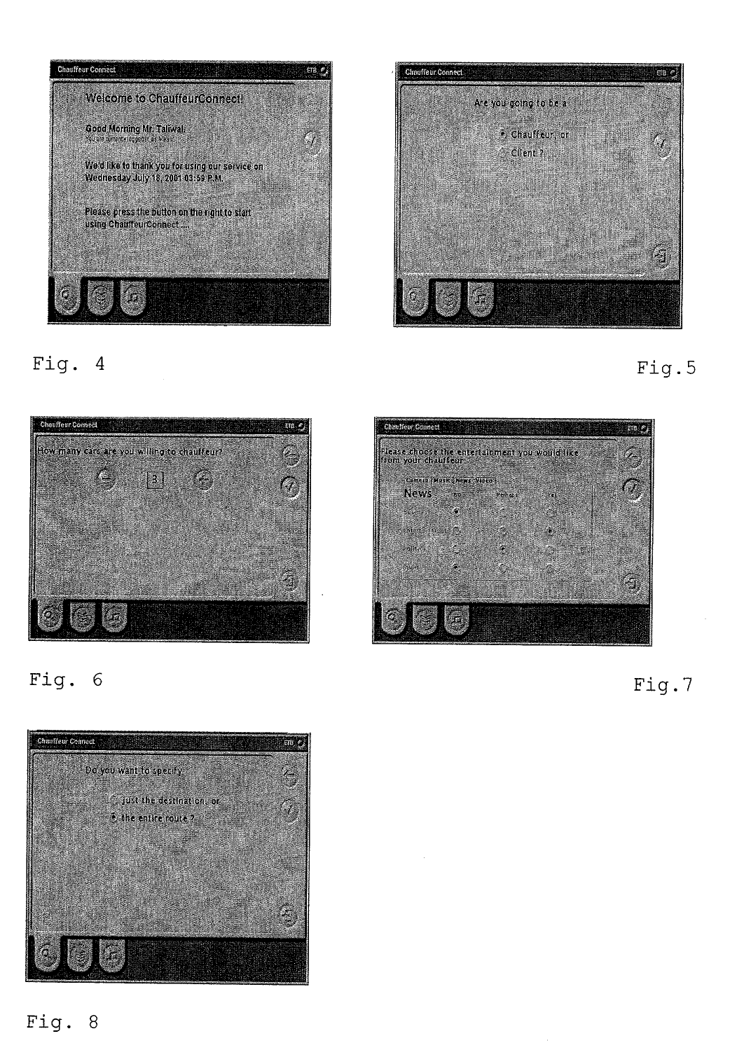

Referring to FIGS. 4 to FIG. 21, the appearance of a chauffeur-connect prototype to its users is described in the following. The prototype illustrates how the three basic system components (FIG. 1) interact with one another. These three components are the Chauffeur—the service provider, the Customer—the service requester, and the Chauffeur-Connect System as the communication and management platform offered by the central service organization. The graphical user interface for both the chauffeur as well as for the customer have the same look and feel. It is designed for use in a car environment. That means that the user should be able to access it with a touchscreen; no keyboard or mouse is necessary to handle the chauffeur-connect application. The screen is divided into three parts—the display in the center of the screen and two navigation bars, one at the bottom and one on the right side. The buttons at the bottom allow the user to select among the applications provided by chauffeur-connect. The buttons on the right side are designed for the navigation through an application.

In the upper right corner of the screen the electronic tow bar (ETB) light is located. This light is turned on as soon as the electronic tow bar between the chauffeur and the customer is engaged. At this point, all premium services are activated and the customer can use them.

At the beginning, the application displays a welcome screen (FIG. 4) with user specific information. A click (touch) on the Select button (the second button on the right hand side) starts the application.

The next screen asks the user if he or she is willing to be a chauffeur or a customer (client) (FIG. 5) in this particular session. In this screen, the “exit” button appears for the first time. The exit button is at the bottom of the right navigation bar. Whenever it is clicked, the application goes back to the welcome screen. After the user has chosen the response, a touch on the select button will start the particular application. Each application type has different settings which the user selects next. So there is a different screen appearance for both chauffeur, FIG. 6, or customer, FIG. 7. The chauffeur sets the number of customers he or she is willing to chauffeur at one time. The customer chooses the services he or she desires from a list of possible premium services.

After the user has chosen settings for the application, the user has to choose the preferred method of route selection (FIG. 8). Chauffeur-connect provides two different types of route selection: a fully automatic one and a manual one. In automatic route selection the user specifies only the starting point and the destination point of the route; the optimal path between the two points is automatically determined by the chauffeur-connect system. If the user selects manual route selection, the user has to choose the path from the starting point through a list of adjacent junctions to the desired destination.

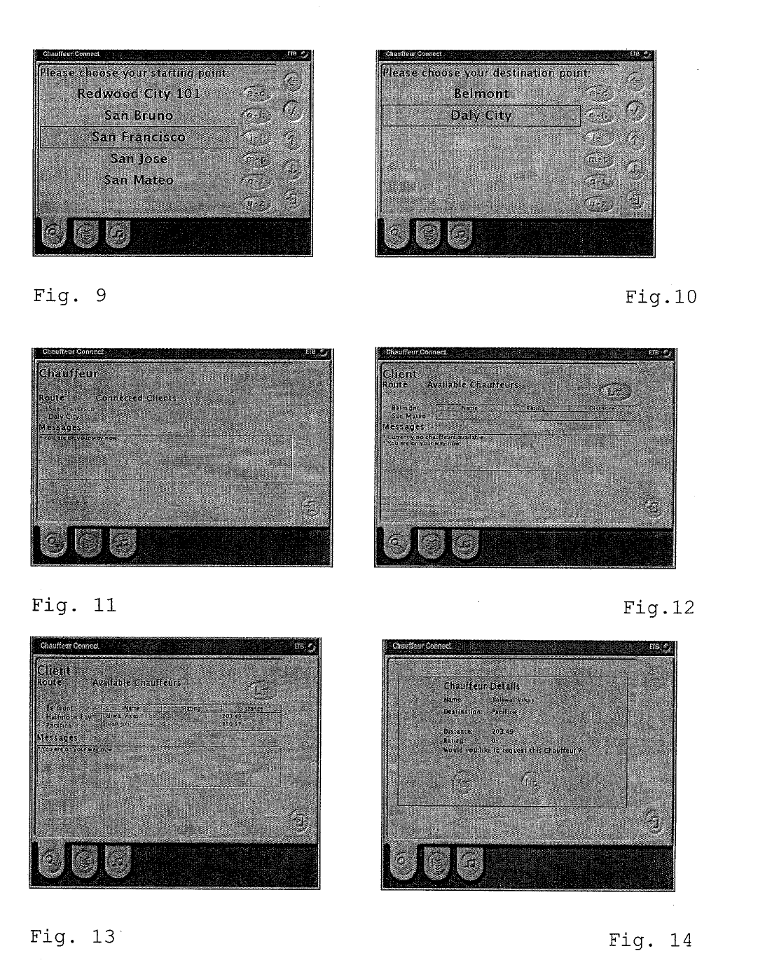

FIG. 9 and FIG. 10 display the automatic route selection process. The user has only to choose the starting point (FIG. 9) and the destination (FIG. 10). The screen provides several new buttons. These buttons are application specific and help the user select the list of junctions from alphabetically ordered groups.

After the user has chosen the route, the application connects to the chauffeur-connect server. The chauffeur-connect server asks the route guidance system to update the database with the latest information and instructs the route guidance system to place the vehicle on the map and guide it through the route (FIG. 21). The route guidance system helps chauffeur-connect to route vehicles through junction to junction to reach their destination point. The route guidance system displays a map of the streets of the region the customer and the chauffeur, who are going to build the multi-car-pool, are currently in. Both the chauffeurs' and customers' locations are tracked on this map, so the participants can be guided to meet at a merging point. Screens for both the chauffeur (FIG. 11) and the customer (FIG. 12) inform the user about their selected routes and display relevant messages informing them of their current status in a messages box. At this point the customer is able to request a chauffeur. As long as the customer is on the road, the customer can request chauffeur-connect for appropriate chauffeurs (FIG. 13). A touch on the List button will send a message to chauffeur-connect to update the list of available and suitable chauffeurs. Within this list, the customer can order the entries after Rating, Distance or Name.

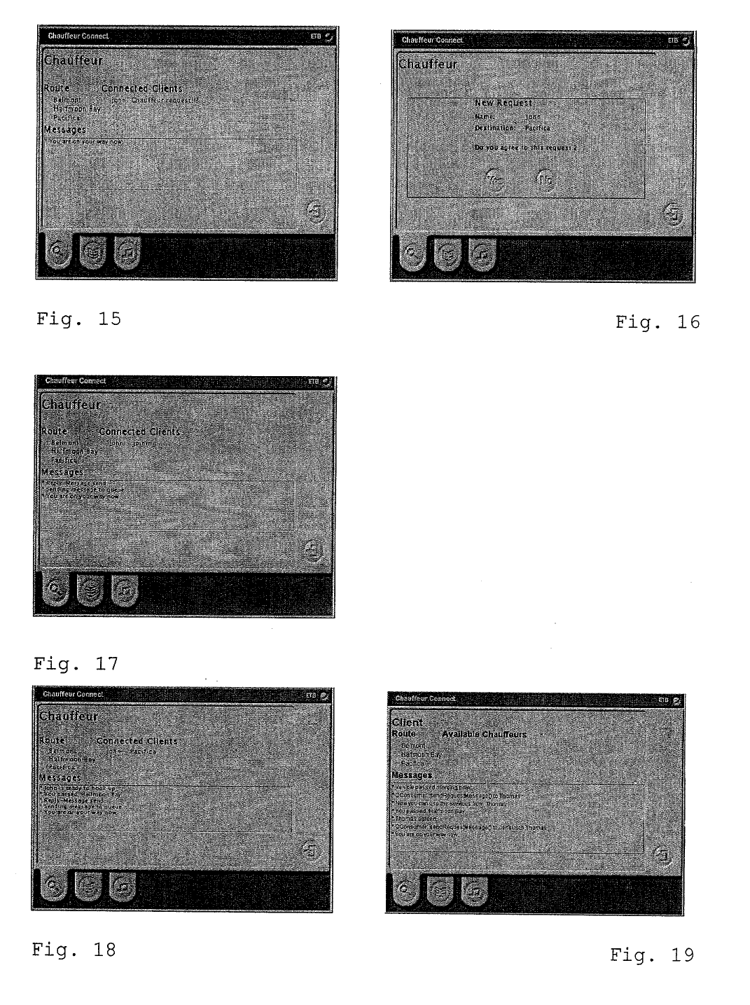

Once the customer has chosen a suitable chauffeur, a request panel (FIG. 14) will pop up and ask the customer if he or she wants to send a chauffeur request to the chauffeur. Whenever the chauffeur receives a request message, it is added to the list of Connected Customers (see FIG. 15). The chauffeur selects an entry in this list to get more information about a customer. The next screenshot (FIG. 16) displays the information a chauffeur gets when he responds to a chauffeur request telling the name of the customer and his or her destination point. Once the yes button is touched, chauffeur and customer will merge at the nearest merging point. The determination of the nearest merging point is the task of the route guidance system. The chauffeur has agreed to the request of the customer. So the customer is added to the customer list (see FIG. 17).

As soon as the customer and the chauffeur pass the merging point, the customer can hook-up. After hooking-up, the chauffeur is responsible for the cars in its caravan and the customers can use the provided premium services. As long as the electronic tow bar is engaged, the light in the upper right corner is turned on. FIG. 18 shows the screen displayed to the chauffeur and FIG. 19 the screen displayed to the customer after the electronic tow bar has been engaged. Now the customer can use additional premium services, offered or brokered from the central service organization without any distraction.

Once the electronic tow bar is engaged, other e-commerce services from the central service organization become available. The chauffeur offers the services directly or as a broker. Examples for such services are:

A news reader, that provides the customer with current news delivered by the chauffeur,

An audio player, that allows the customer to access MP3 files in the chauffeur's multi-media database, and

Camera views to allow the customer to, for example, have a front view, i.e. out of the chauffeur's windshield.

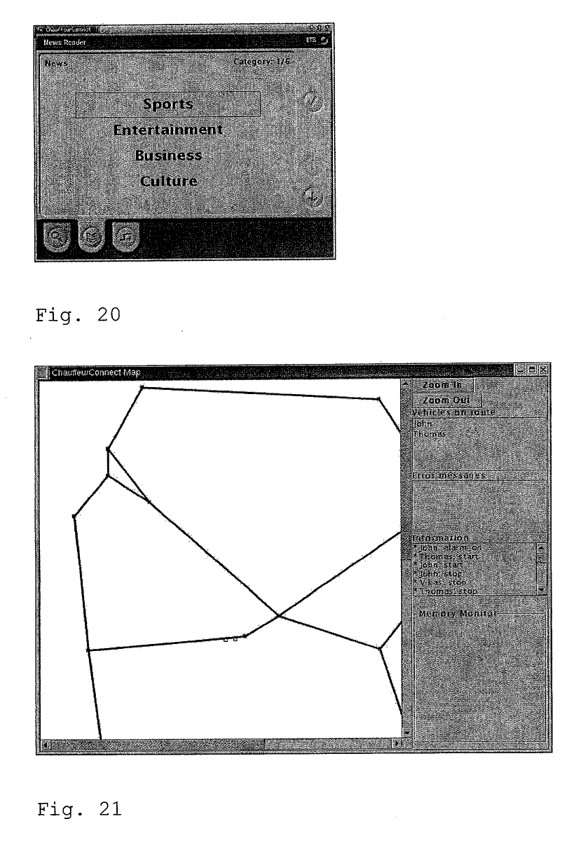

The news reader automatically retrieves the list of available content from the chauffeur and displays a list of available categories (see FIG. 20). Using the “Up” and “Down” buttons, the customer can select a category, in the illustrated example it is Sports, and then press the Select button to enter this category. The number of categories and subcategories is generally not limited, which allows for maximum flexibility when designing the news content. In any case, the Back button will take the customer to the previous screen. The screen shots also show that the appropriate buttons are shown as available or grayed, i.e. not available at the moment.

An audio player allows the customer to listen to a selection of music the chauffeur provides (e.g. MP3 files). Pressing a “Play” button will download the selected track from the chauffeurs multi-media database and start playing the song. The player behaves like a CD player.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method of organizing a multi-car-pool having a leading car and at least one follower customer car, the method comprising the acts of:
(a) registering participants in a central service organization, each of the participants potentially being a chauffeur of the leading car and/or a follower customer in the multi-car-pool;
(b) providing an electronic service platform to enable registered participants to submit their intended driving route and driving direction and travelling timeframe to the central service organization;
(c) assembling participants having submitted their intended driving route and driving direction and travelling timeframe, who are having the same intended driving direction and overlapping travelling timeframe and sharing at least a part of their routes to build a multi-car-pool by the central service organization; and
(d) submitting information to a chauffeur and one or more customers assembled to build the multi-car-pool and to enable them to identify each other.

2. The method of claim 1, wherein the multi-car-pool is an electronic tow-bar platoon.

3. The method of claim 1, wherein the assembling of the participants further comprises the act of bringing together participants and enabling them to negotiate via the central service organization.

4. The method of claim 1, wherein the service platform enables the participants to submit their intent whether they are willing to be a chauffeur or a follower customer, to the central service organization.

5. The method of claim 4, further comprising the acts of:
(a) displaying participants who submitted their intent to be willing to be a chauffeur to at least one participant by the electronic service platform, and
(b) enabling, with the electronic service platform, these participants to submit a chosen chauffeur of the displayed chauffeurs to the central service organization.

6. The method of claim 4, wherein the service platform further enables the participants to define a maximum number of cars building the multi-car-pool they want to join, and to submit said maximum number to the central service organization.

7. The method of claim 1, wherein the identification of the participants of an assembled multi-car-pool is supported by a participant locating service and a route guidance service.

8. The method of claim 1, wherein the electronic service platform is an internet application.

9. The method of claim 1, wherein the electronic service platform offers at least one of entertainment programs and news services to the follower customers.
